(19) United States
(12) Patent Application Publication
(10) Pub. No.: US 2002/0196501 A1
(43) Pub. Date: Dec. 26, 2002

(54) Tandem optoelectronic transciver package and method of operating an optical fiber communication network employing the same

(76) Inventors: Robert Buss, Brick, NJ (US); John Loughlin, Lebanon, NJ (US); Emory Anderson, Forest Hills, NY (US); Anthony Jayakumar, Bridgewater, NJ (US); Michael Guarnaccia, Allendale, NJ (US)

Correspondence Address: Brian K. Dinicola, 34 Avenue E, Monroe Twp, NJ, 08831-2316, US

(21) Appl. No.: 09/892,181

(22) Filed: Jun. 26, 2001

(51) Int. Cl. H04B 10/00

(52) U.S. Cl. 359/152; 359/163

(57) ABSTRACT

An optical transceiver circuit pack in which specialized components, i.e., optical components associated with transmitting and receiving at a first wavelength or first band of wavelengths, are arranged on a first optical transceiver card section constituting a first module, and wherein generic components, i.e., electronic components which are arranged and operable to electrically interact with any first module regardless of its particular wavelength or band of wavelengths, are arranged on a second optical transceiver card section constituting a second module, the respective modules being detachably coupled to one another such that the first module may be replaced with either an identical module (i.e., one being configured to transmit and receive at said first wavelength or first band of wavelengths) or a different module (i.e., one being configured to transmit at a wavelength or band of wavelengths different than said first wavelength or first band of wavelengths. Advantageously, it is no longer necessary to maintain, in an inventory of spares, an entire optical transceiver circuit pack for each different operating wavelength of an optical communication system. Rather, a comparatively small number of second modules may be stored relative to the number of first modules since the former are common to all of the transceiver circuit packs regardless of transmission wavelength. As such, the overall cost of maintaining an adequate inventory of spare optical transceiver circuit packs is substantially reduced.

### BACKGROUND OF THE INVENTION

1. Field of the Invention

The present invention relates generally to optical devices and, more particularly, to the efficient packaging of interoperable optical assemblies and electronic circuits collectively forming an optical transceiver structure.

2. Discussion of the Prior Art

In a fiber optic telecommunication or data communication system, optical fibers serve to carry pulse coded optical signals from a transmitter station, perhaps to one or more repeater stations or intermediate transmission nodes, and then to a receiver station. Each optical signal is received or transmitted by a photoelectric device. In the case of a receiver, the photoelectric device will usually be a photodiode, such as a pin photodiode or an avalanche photodiode, for which an electrical amplifier can be placed after the photodiode to boost the electrical signal. In the case of the transmitter, the photoelectric device comprises a source of optical energy such, for example, as a light emitting diode or laser, the optical signal produced being tuned to a specific wavelength suited for transmission over an optical fiber link of specific length and optical properties.

The aforementioned optical components, which are said to comprise a transceiver structure, are generally provided as part of an integrated optoelectronic assembly known as a circuit pack. An illustrative circuit pack structure 10 is depicted in FIG. 1 and includes the transceiver optics, consisting of first and second photoelectric devices indicated generally at 12 and 14 and performing optical signal receiving and transmitting functions, respectively. An analog to digital (A/D) converter circuit indicated generally at 16 is provided to convert the electrical output of the photoelectric receiver device 12 into a digital stream corresponding to the optically transmitted data arriving from a remote receiver (not shown) via an optical link as fiber link 18. Likewise, a digital to analog (D/A) converter circuit indicated generally at 20 is provided to convert a digital stream to be transmitted to a remote receiver via an optical link as fiber link 22. Conventional framing and timing functions, with respect to the arriving and outgoing signals, are performed by timing and framing circuits 24 and 26, respectively.

As will be readily appreciated by those skilled in the art, the dense wavelength division multiplexed optical communication systems of today may contemplate the transmission of 40, 80, 160 or more individual optical signals over a single fiber—with each such signal being at a respectively different wavelength than the others. The inventors herein have recognized that a primary disadvantage associated with realizing the transceiver circuit pack as a single, unitary board structure, containing both the optical and electronic components, is that it compels a system owner or operator to have on hand, for each operating transmission wavelength of the system, a spare circuit pack. That is, in the event a specific transceiver circuit pack should fail, only an identical transceiver circuit pack—one capable of transmitting and receiving at the same particular wavelength as the failed pack, can be placed in service as a replacement. The spare stocking requirement, while heretofore deemed a commercially necessary precaution in order that the system operator may safely make and honor its commitments to subscribers, adds substantially to both the capital cost of the initial system purchase and the maintenance, upgrading and/or re-configuration of the system thereafter.

It will also be appreciated that different optical components from different vendors may require different board layouts or configurations. A detachable optical transceiver pack in accordance with the present invention permits adaptation using different mechanical configurations of the transceiver—a key advantage given the persistent problem of long component ordering lead times and unpredictable availability.

There thus exists a continuing need for an optical transceiver circuit pack or card that is designed to reduce the capital expense of the system owner or operator who desires to ensure reliable, continued system operation. Moreover, from the standpoint of serviceability, there exists a need for an optical transceiver circuit pack which may be easily accessed and serviced by maintenance personnel.

### SUMMARY OF THE INVENTION

The aforementioned need is addressed, and an advance is made in the art, by an optical transceiver circuit pack in which specialized components, i.e., optical components associated with transmitting and receiving at a particular wavelength or band of wavelengths, are arranged on a first optical transceiver card section constituting a first module, and wherein generic components, i.e., electronic components which are arranged and operable to electrically interact with any first module regardless of its particular wavelength or band of wavelengths, are arranged on a second optical transceiver card section constituting a second module, the respective modules being detachably coupled to one another such that the first module may be replaced with either an identical module (i.e., one being configured to transmit and receive at said first wavelength or first band of wavelengths) or a different module (i.e., one being configured to transmit at a wavelength or band of wavelengths different than said first wavelength or first band of wavelengths.

The system of the present invention thus overcomes a deficiency of the prior art in that it is no longer necessary to maintain, in an inventory of spares, an entire optical transceiver circuit pack for each different operating wavelength of an optical communication system. Rather, a comparatively small number of second modules may be stored relative to the number of first modules since the former are common to all of the transceiver circuit packs regardless of transmission wavelength.

In accordance with a method of operating and maintaining an optical communication system comprising a plurality of optical transceivers, wherein each optical transceiver comprises first and second modules detachably coupled to one another, specialized components, i.e., optical components associated with transmitting and receiving at a wavelength or band of wavelengths are arranged on a first optical transceiver card section constituting the first module, and generic components, i.e., electronic components which are arranged and operable to electrically interact with any first module regardless of its particular wavelength or band of wavelengths, are arranged on a second optical transceiver card section constituting a second module. The method includes a step of operating a first optical transceiver, in which the first module contains optical components operative to transmit and receive at a first wavelength or band of wavelengths, and a step of operating a second optical transceiver, in which the first module contains optical components operative to transmit and receive at a second wavelength or band of wavelengths.

The method further comprises storing a first number of the first modules and a second number of the second modules as spares, the second number being less than said first number, and a step of removing a malfunctioning one of said first and second optical transceivers. The method further comprises a step of detaching the first and the second modules of the optical transceiver removed during the removing step, determining which of the first and second modules removed during the removing step is malfunctioning, and replacing a module determined to be malfunctioning from one of the spares stored during the storing step.

### BRIEF DESCRIPTION OF THE DRAWINGS

The various novel features and aspects of the present invention will be better understood upon reference to the detailed description which follows taken in conjunction with the drawings, in which:

FIG. 1 depicts a conventional optical transceiver circuit pack;

FIG. 2 is a simplified perspective view of a tandem optical transceiver circuit pack constructed in accordance with an illustrative embodiment of the present invention; and

FIG. 3 is a front elevation view of an equipment bay structure housing a plurality of tandem optical transceiver circuit packs constructed in accordance with the present invention, with a first circuit pack being operative to transmit and receive optical signals at a first wavelength and a second circuit pack being operative to transmit and receive optical signals at a second wavelength.

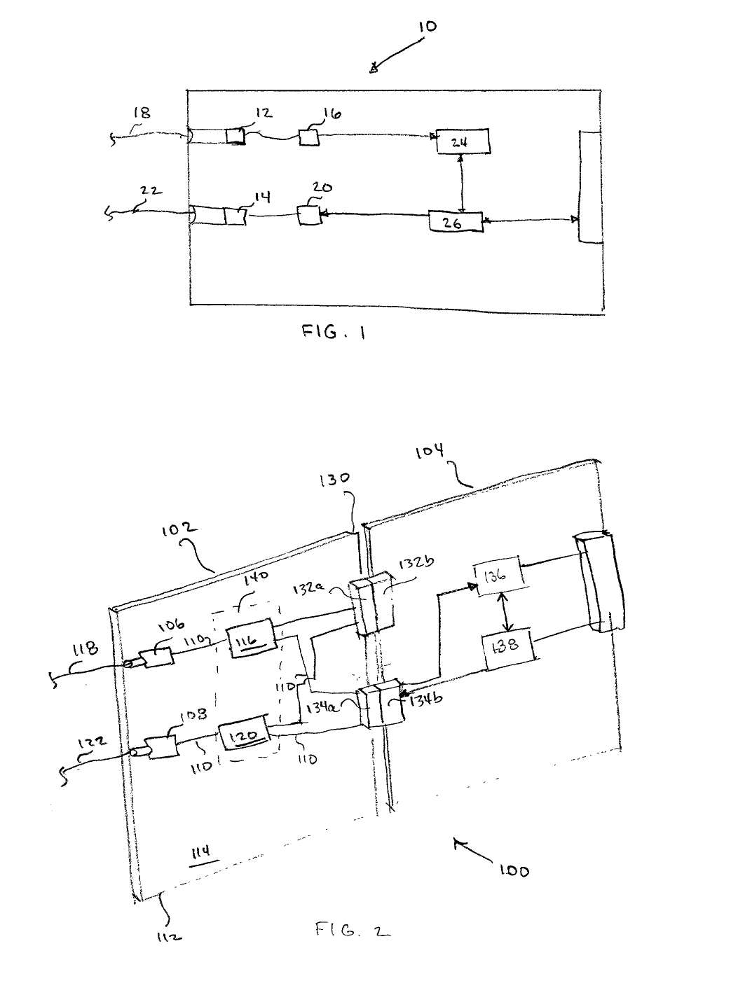

### DETAILED DESCRIPTION OF THE INVENTION

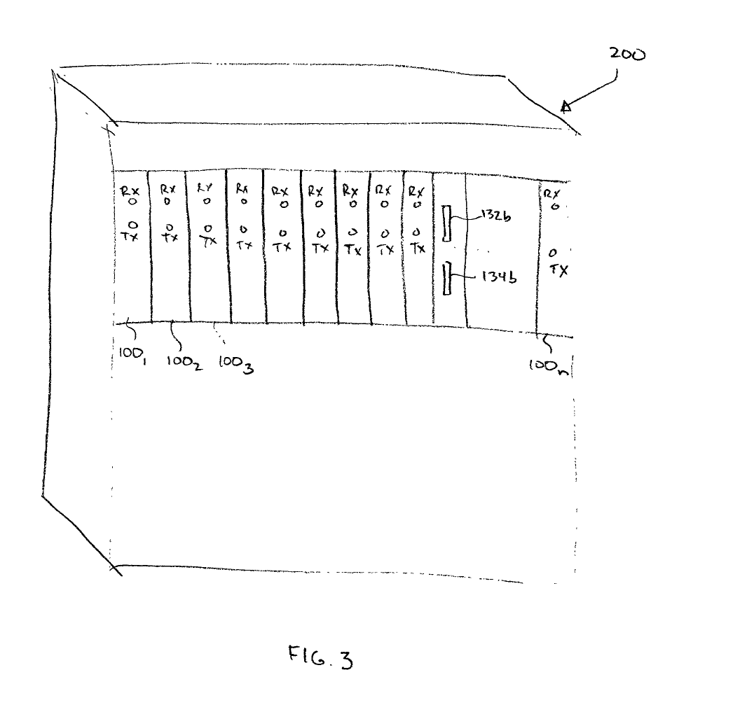

With initial reference to FIG. 2, there is shown a simplified perspective view of a tandem optical transceiver circuit pack 100 constructed in accordance with an illustrative embodiment of the present invention. As seen in FIG. 2, tandem circuit pack 100 comprises a first module 102 and a second module 104, which are respectively detachable from one another. Essentially, detachable first module 102 includes several major elements, such as photoelectric receiver device 106 and photoelectric transmitter device 108, electrical leads 110, and a substrate 112 having a surface 114. An analog to digital (A/D) converter circuit, which in the illustrative embodiment of FIG. 2 is implemented as an integrated circuit chip function indicated generally at 116, is provided to convert the electrical output of the photoelectric receiver device 106 into a digital stream corresponding to the optically transmitted data arriving from a remote receiver (not shown) via an optical link as fiber link 118. Likewise, a digital to analog (D/A) converter circuit function indicated generally at 120 is provided to convert a digital stream to be transmitted, via photoelectric transmitter device 108, to a remote receiver via an optical link as fiber link 122.

As will be readily appreciated by those skilled in the art, the optical wavelengths at which the photoelectric devices 106 and 108 are operable to receive and transmit, respectively, will be dependent upon the particular requirements of the system into which the tandem optical transceiver 100 will be installed. By way of illustrative example, the system might employ first and second optical fiber links, as fiber links 118 and 120 of the embodiment of FIG. 2, to achieve bi-directional communication between a remote node (not shown) and the local node in which the tandem optical transceiver 100 is installed. In such event, it may be desirable for the photoelectric devices 106 and 108 to receive and transmit, respectively, at the same wavelength. Alternatively, however, it may be desirable to establish a bi-directional link between nodes using a single optical fiber. In such event, it will be appropriate instead to use photoelectric devices that are operable to transmit and receive, respectively, at different wavelengths. Where only one optical fiber is employed, module 102 may be configured with a single ferrule (not shown) for receiving the fiber and an appropriate optical coupler (not shown) for allowing optical energy to be both supplied via the fiber to photoelectric receiver device 106 and launched into the fiber via photoelectric transmitter device 108.

With continuing reference to FIG. 2, it will be seen that a rear edge 130 of transceiver module 102 has arranged therealong a suitable connector assembly for establishing electrical power and signal connections with second module 104. Advantageously, and in accordance with an aspect of the present invention, this arrangement allows the electrical and electronic functions of the transceiver circuit which are generic (i.e., not dependent upon the specific optical wavelength(s) associated with photoelectric devices 106 and 108) to be remotely situated on a detachable module that can be easily replaced when only those electrical/electronic functions are affected by a malfunction or component failure. In accordance with the illustrative embodiment depicted in FIG. 2, the connector assembly includes a first power connector 132a and a first digital signal connector 134a disposed along rear edge 130 of module 102. For establishing interconnectivity between detachable modules 102 and 104, the connector assembly further includes a second power connector 132b dimensioned and arranged for mating electrical contact with first power connector 132a and a second digital signal connector 134b dimensioned and arranged for mating electrical contact with first digital signal connector 134a, whereby the first and second transceiver module sections 102 and 194 are oriented in a common vertical plane when coupled together for insertion into an equipment backplane.

As will be readily appreciated by those skilled in the art, and as mentioned earlier, any functions which are independent of the optical wavelength of transmission may be situated on module 104. By way of illustrative example, these functions may include conventional framing and timing functions, as performed by integrated circuit chips 136 and 138, with respect to the arriving and outgoing signals being exchanged between the local node (in which tandem transceiver circuit 100 is installed) and a remote node (not shown).

In order to permit insertion of the assembled modules into an equipment backplane as an operative transceiver, the substrates of each module as first module 102 are preferably realized as as complementary ceramic interconnect substrates, FR4 boards, printed circuit boards (PCBs), or the like. Selection of substrate 112 is application specific; however, depending upon the specific selection of substrate 112, a variety of different electrical interconnections are possible. For example, by selecting and using a ceramic interconnect substrate, the FR4 board, or the PCB, substrate 112 is enabled to have a plurality of electrical traces, illustrated by electrical traces 110 and bonding pad 111, to be disposed on surface 114 of substrate 112, thus enabling electrical 111 interconnections and electrical signals to travel to various photoelectric devices and standard electronic components through the plurality of electrical traces 110 mounted on substrate 112.

Photoelectric devices 106 and 108 are mounted on substrate 112 and operably connected to leads 110 using any suitable method, such as TAB, conductive bumps, wire bonding, soldering, or the like. Generally, photoreceiver 106 may be realized as a photodiode, a PIN photodiode, or the like, while phototransmitter 108 is typically realized as a laser (e.g. vertical cavity surface emitting laser), a light emitting diode, or the like. The electrical conversion functions as 116 and 120 performed on detachable first module 102 may, to the extent practicable, be realized by surface mounted integrated circuits such as integrated circuit (IC) 140, as well as discrete standard electronic components such, for example, as capacitors, resistors, logic devices, amplifiers, and the like (not shown) on substrate 102 by any suitable method, such as TAB conductive bumps, wire bonding, soldering, or the like. The same is true of those components associated with the generic functions to be performed on module 104. However, it should be understood by those skilled in the art, that selection of these standard electronic components, and allocation of these between the respective modules, is application specific and may vary from application to application.

With reference now to FIG. 3, there is shown a front elevation view of an equipment bay structure 200 housing a plurality of tandem optical transceiver circuit packs 100₁-100ₙ constructed in accordance with the present invention, with a first circuit pack 100₁ being operative to transmit and receive optical signals at a first wavelength and at least a second circuit pack 100₂ being operative to transmit and receive optical signals at a second wavelength. According to the present invention, the owner or operator of a system in which structure 200 is integrated into a network node, may maintain different numbers of spares for each of modules 102 and 104. Specifically, and as should be understood from the preceding discussion, while module 104 may be configured a structure which is common to all optical transceivers, each of circuit packs 100₁ through 100ₙ will typically operate at a different wavelength and, hence, at least some of first modules will differ from other first modules. Accordingly, for a given network incorporating optical transceiver circuit packs constructed in accordance with the present invention, the number of spare second modules stored is substantially lower than a total number of stored first modules.

A method of operating and maintaining a network comprising tandem optical transceiver circuit packs in accordance with the present invention therefore includes operating a first optical transceiver, the first module of the first optical transceiver containing optical components operative to transmit and receive, respectively, at one of a first common wavelength and first and second correspondingly different wavelengths and operating a second optical transceiver, the first module of the second optical transceiver containing optical components operative to at least one of transmit and receive at a wavelength different from the first common wavelength or first and second correspondingly different wavelengths. The method further includes a step of storing, as replacement spares, at least one first module for each operating transmission wavelength of the optical communication system and at least one of the second modules, the number of spare second modules stored during said storing step being substantially lower than a total number of stored first modules. The method further includes a step of removing a malfunctioning one of the first and second optical transceivers, detaching the first and the second modules of the optical transceiver removed during the removing step, determining which of the first and second modules removed during the removing step is malfunctioning, and replacing only a module determined to be malfunctioning from one of the spares stored during the storing step.

By now it should be appreciated that a novel detachable optical transceiver circuit and methods of utilizing the same have been described. The detachable optical interconnect unit allows for efficient placement of photoelectric devices in a cost effective manner, thus allowing their usage in optical electronic modules with standard electronic components. Additionally, this configuration permits both standard electronic components and optical components to be combined, while allowing the system owner and operator to reduce the capital cost of provisioning and maintaining their networks.

Although the present invention has been described with reference to certain illustrative embodiments, other embodiments are possible and will be readily apparent to those skilled in the art. Therefore, the spirit and scope of the appended claims should not be limited to the embodiments contained in this description.

What is claimed is:

1. An optical transceiver assembly for transmitting and receiving optical signals at a selected wavelength, said optical transceiver assembly comprising:
a first optical transceiver card section constituting a first module, said first module having mounted thereon optical assemblies operable to transmit and receive, respectively, optical signals at one of a common wavelength and correspondingly different wavelengths; and
a second optical transceiver card section constituting a second module, said second module having mounted thereon electronic components operable to exchange electrical signals with said optical components,
wherein said first and second modules are detachably coupled to one another and wherein the first module may be replaced, relative to its coupling to the second module, with either an identical module having mounted thereon optical assemblies respectively operable to transmit and receive at said corresponding wavelengths or a module having mounted thereon optical assemblies each operable to transmit and receive, respectively, optical signals at wavelengths different than said one of a common and correspondingly different wavelengths.

2. The optical transceiver assembly of claim 1, wherein a first of said optical assemblies comprises one of a p-i-n photodiode and an avalanche photodiode for converting a received optical signal into a corresponding electrical signal.

3. The optical transceiver assembly of claim 2, wherein said first optical transceiver card section further includes an analog to digital converter circuit operatively associated with said first optical assembly to generate a digital representation of said received optical signal.

4. The optical transceiver assembly of claim 2, wherein a second of said optical assemblies comprises one of a laser and a light emitting diode responsive to an input analog electrical signal to emit optical signals for transmission to a remote receiver.

5. The optical transceiver assembly of claim 4, wherein said first optical transceiver card section further includes a digital to analog circuit to drive said laser or light emitting diode with an input analog electrical signal representative of data to be transmitted to a remote receiver.

6. The optical transceiver assembly of claim 1, wherein optical assemblies of said first module are operable to transmit and receive, respectively, at the same wavelength.

7. The optical transceiver assembly of claim 1, wherein optical assemblies of said first module are operable to transmit and receive, respectively, at different wavelengths.

8. The optical transceiver assembly of claim 1, wherein a rear edge of said first transceiver card section has arranged thereon a first power connector and a first digital connector, and wherein a forward edge of said second transceiver card section has arranged thereon a second power connector dimensioned and arranged for mating electrical contact with said first power connector and a second digital connector dimensioned and arranged for mating electrical contact with said first digital connector, whereby said first and second transceiver card sections are oriented in a common vertical plane when coupled together for insertion into an equipment backplane.

9. A method of operating and maintaining an optical communication system including a plurality of optical transceivers connected to a backplane, each optical transceiver having first and second modules detachably coupled to one another such that optical assemblies associated with transmitting and receiving, respectively, at one of a common and respectively different wavelengths are arranged on a first optical transceiver card section constituting the first module and such that electronic components operable to electrically interact with components of any first module of any of said plurality of optical transceivers are arranged on a second optical transceiver card section constituting the second module, said method comprising the steps of:
operating a first optical transceiver, the first module of said first optical transceiver containing optical components operative to transmit and receive, respectively, at one of a first common wavelength and first and second correspondingly different wavelengths;
operating a second optical transceiver, the first module of said second optical transceiver containing optical components operative to at least one of transmit and receive at a wavelength different from said first common wavelength or first and second correspondingly different wavelengths.

10. The method of claim 9, further including a step of storing, as replacement spares, at least one first module for each operating transmission wavelength of the optical communication system and at least one of said second modules, the number of spare second modules stored during said storing step being substantially lower than a total number of stored first modules.

11. The method of claim 10, further including a step of removing a malfunctioning one of said first and second optical transceivers, detaching the first and the second modules of the optical transceiver removed during the removing step, determining which of the first and second modules removed during the removing step is malfunctioning, and replacing only a module determined to be malfunctioning from one of the spares stored during the storing step.

12. An optical communication system, comprising:
a plurality of optical transceivers connected to a backplane, each optical transceiver having first and second modules detachably coupled to one another such that optical assemblies associated with transmitting and receiving, respectively, at one of a common and respectively different wavelengths are arranged on a first optical transceiver card section constituting the first module and such that electronic components operable to electrically interact with components of any first module of any of said plurality of optical transceivers are arranged on a second optical transceiver card section constituting the second module, wherein
in a first optical transceiver of the plurality of optical transceivers, the first module contains optical components operative to transmit and receive, respectively, at one of a first common wavelength and first and second correspondingly different wavelengths;
in a second optical transceiver of the plurality of optical transceivers, the first module contains optical components operative to at least one of transmit and receive at a wavelength different from said first common wavelength or first and second correspondingly different wavelengths.

13. The system of claim 12, wherein a first optical assembly of each first module comprises one of a p-i-n photodiode and an avalanche photodiode for converting a received optical signal into a corresponding electrical signal.

14. The system of claim 12, wherein each said first optical transceiver card section further includes an analog to digital converter circuit operatively associated with said first optical assembly to generate a digital representation of a corresponding received optical signal.

15. The system of claim 12, wherein a second optical assembly of each first module comprises one of a laser and a light emitting diode responsive to an input analog electrical signal to emit a respective optical signal for transmission to a remote receiver.

16. The system of claim 15, wherein each said first optical transceiver card section further includes a digital to analog circuit to drive said laser or light emitting diode with an input analog electrical signal representative of data to be transmitted to a remote receiver.

17. The system of claim 12, wherein optical assemblies of at least one first module are operable to transmit and receive, respectively, at the same wavelength.

18. The system of claim 12, wherein optical assemblies of at least one first module are operable to transmit and receive, respectively, at different wavelengths.

19. The system of claim 12, wherein a rear edge of each said first transceiver card section has arranged thereon a first power connector and a first digital connector, and wherein a forward edge of each said second transceiver card section has arranged thereon a second power connector dimensioned and arranged for mating electrical contact with said first power connector and a second digital connector dimensioned and arranged for mating electrical contact with said first digital connector, whereby respective pairs of said first and second transceiver card sections are oriented in a common vertical plane when coupled together for insertion into said equipment backplane.
